(19) United States
(12) Patent Application Publication
(10) Pub. No.: US 2021/0007520 A1
(43) Pub. Date: Jan. 14, 2021

(54) COMPOSTABLE CUTLERY

(71) Applicant: Tipi Eco Ltd, Llandilo Graban (GB)

(72) Inventor: Jacqui Horton, Llandilo Graban (GB)

(21) Appl. No.: 16/927,440

(22) Filed: Jul. 13, 2020

(30) Foreign Application Priority Data
Jul. 11, 2019 (GB) 1909956.3

(51) Int. Cl. A47G 21/04; B31F 5/04

(52) U.S. Cl. CPC A47G 21/04; B31F 5/04

(57) ABSTRACT

Compostable cutlery utensils made by forming a pliable composite sheet having an internal substrate of overlaying food-grade paper sheets of collective number and thickness suitable for making a required item of cutlery, the internal paper sheets each being coated with a settable food-grade adhesive substance, such as by being dipped into a bath of liquid glue, applying an outer covering of food-grade paper to each major external side of the substrate to form a pliable composite sheet, thereafter forming the shape of the utensil, such as by the use of a two-part mould in the collective shape and size of the required utensil, removing, such as by cutting, the formed utensil from the composite sheet before the adhesive has set, and thereafter allowing or causing the adhesive substance to set to thereby produce a rigid compostable cutlery utensil.

This application claims priority to British Patent Application No. 1909956.3 filed on Jul. 11, 2019, the disclosure of which is incorporated herein by reference.

### TECHNICAL FIELD

This invention relates to disposable cutlery such as knives, forks and spoons where, after use, they can be disposed of in an environmentally friendly manner.

### BACKGROUND

It is well-known that one-use plastics utensils and containers do not easily biodegrade after use and can easily survive for several centuries in landfill sites or in ocean and other water systems. Incineration is another disposal option, but this causes toxic waste in the form of smoke which has to be treated, such as by chemical scrubbing, meaning that the entire process is wasteful of the Earth's natural oil resources and expensive. An improvement to this situation has been the development of PLA or polylactic acid, or polylactide, being a thermoplastic aliphatic polyester derived from renewable biomass such as fermented plant starch from corn, cassava, sugarcane and sugarbeet. The end product can be formed by moulding or extrusion processes just as with conventional food-grade plastics to make relatively rigid utensils and containers which, after use, are biodegradable. However, the chemical composition of PLA is such that it does not naturally biodegrade within a conveniently short period and, accordingly, industrial processes are needed to process PLA products after use, which is inconvenient and expensive. If they are not processed industrially, they do not readily biodegrade and are similar to traditional plastics in their lifespan and impact on the planet

An alternative to PLA is the use of wood, which is an environmentally friendly and renewable material but has distinct disadvantages when used for disposable cutlery, the first of which being that it can leave an unpleasant taste in the mouth due to naturally occurring chemicals in the wood, which include natural insecticides. Wood is also very stiff and so it is difficult to form into the shape of utensils such as bowls and spoons other than by means of cutting away the required material into a shape with suitably bladed tools, which is wasteful of the removed material and also time-consuming. There is also a problem with disposal of wooden utensils, because wood is not compostable in the normally accepted sense, taking a relatively long time to biodegrade, and if incinerated the resulting carbon and toxic emissions are released into the atmosphere.

The present invention is derived from the realisation that there is a need for an alternative to the use of PLA or wood for disposable utensils such as cutlery which has the benefits of strength and durability whilst in use yet, after use, are easily biodegradable to the extent that they are compostable, that is to say, they can be added to other biomass such as unwanted vegetables, grass cuttings and garden weeds which are normally deposited on a compost heap or in a suitable composting container, whereafter through the action of microbes and small animals such as worms and insects the biomass is relatively quickly converted into re-usable compost.

### SUMMARY

According to a first aspect of the invention there is provided a method of making compostable cutlery utensils, the method including the steps, in any convenient order, of forming a pliable composite sheet comprised of an internal substrate of overlaying food-grade paper sheets of collective number and thickness suitable for making a required item of cutlery, the internal paper sheets each being coated with a settable food-grade adhesive substance, such as by being dipped into a bath of liquid glue, applying an outer covering of food-grade paper to each major external side of the substrate to form a pliable composite sheet, thereafter forming the shape of the utensil, such as by the use of a two-part mould in the collective shape and size of the required utensil, removing, such as by cutting, the formed utensil from the composite sheet before the adhesive has set, and thereafter allowing or causing the adhesive substance to set to thereby produce a rigid compostable cutlery utensil.

In this patent specification the term “a collective number and thickness suitable for making a required item of cutlery” means sufficient for providing the necessary volume and strength for the utensil under construction to be used for its intended purpose after the adhesive is set such that, in the case of cutlery in the form of a spoon, the finished spoon is strong enough to be used during eating so as to prevent unintended spillage of solid or liquid foodstuffs from the spoon, and in the case of cutlery in the form of a knife, is strong enough to enable the knife to cut through solid foodstuffs including meat. Similarly, in the case of cutlery in the shape of a fork, the prongs of the fork are strong enough to pierce food such as meat without the food collapsing, whereas a correspondingly-shaped fork made from a single sheet of paper or thick card would be unable to do this.

Conveniently, the number of sheets in the substrate for forming utensils in the shape of cutlery is between 6 and 10 such sheets and preferably between 7 and 9 such sheets, where it has been found that utensils formed from a composite multi-layer sheet, with food-grade adhesive therebetween, is strong enough for its intended purpose after the adhesive has been cured or has otherwise set.

Preferably, the outermost paper sheets covering the composite multi-layer substrate are not coated with adhesive, leaving them generally dry and available for e.g. over-printing using food-grade inks either before or after being applied to the internal substrate.

Preferably, the outer covering sheets are thinner than the innermost sheets of the substrate, such as the innermost sheets each being 120 g and the outermost sheets being 63 g. This arrangement has the advantage in minimising or preventing creasing during the moulding process whilst with thinner outer sheets a very precise or “crisp” and detailed cut and form to be made around the peripheral edges of the utensil. This is a particularly useful feature where the utensil requires a cutting or piercing edge, such as in the case of a cutlery item in the form of a knife or fork. The outermost sheets of paper may also conveniently be provided with a food-grade waterproofing agent such as oil, wax or acrylic, thereby preventing any contamination of the innermost sheets while providing a smooth outer surface over which food items may easily slide during consumption and therefore not adversely affecting the cutlery user enjoyment.

Conveniently, the adhesive used in the manufacturing process is UV curable, for example Henkel Adhesive AQUENCE BG 9040 LM, and in the preferred method of the invention there is included, the further step of forming the utensil while the adhesive is still wet or is otherwise not set or cured and thereafter causing the adhesive to harden by exposing it to UV radiation, such as in a shielded chamber surrounding a conveyor belt which also provides a degree of sterilisation for the finished cutlery items during the hardening process.

According to a second aspect of the invention there is provided a cutlery utensil made in accordance with the method of the invention.

With these arrangements, and in particular with the surprising realisation that multiple sheets of food-grade paper can, when loosely bonded together with a suitable adhesive, be used to form a required utensil which, after forming and the adhesive becoming cured or set, is nevertheless strong enough to perform its intended function even to the extent of cutting meat, in the case of cutlery in the form of a knife, or piercing and holding hot food during dining, in the case of a fork. In contrast, it is known that a single sheet of food-grade cardboard of thickness equivalent to the composite multi-layer utensil of the invention has considerably less strength and rigidity such that, in practice, it is entirely unsuitable for use in making utensils such as cutlery. It is therefore believed that although each single sheet of the multi-layer composite substrate has no discernable grain orientation, in contrast to thin veneers of wood used to make rigid plywood, the provision of an adhesive between each layer is sufficient, in combination with all other such layers in the composite sheet, to be flexible enough to form three-dimensional shapes such as spoons as well as essentially two-dimensional shapes such as knives, where generally sharp surfaces are required for cutting foodstuffs, whereafter upon the adhesive being cured or otherwise set, preferably by being exposed to UV radiation, it becomes sufficiently hard and rigid such that it is ready for use.

### BRIEF DESCRIPTION OF THE DRAWING FIGURES

The invention will now be described, by way of example only, with reference to the accompanying drawings in which:

FIG. 1 is a perspective view of a prior art disposable spoon made of plastics,

FIG. 2 is a perspective view of a disposable spoon made in accordance with the method of the invention with a full 3D curve to the mould,

FIG. 3 is an enlarged sectional view across “A-A” of the spoon in FIG. 2,

FIG. 4 is a perspective view of a disposable knife made in accordance with the method of the invention cut flat with a shaped edge to the mould,

FIG. 5 is a schematic view of a method of making a plurality of disposable forks according to the invention.

### DETAILED DESCRIPTION

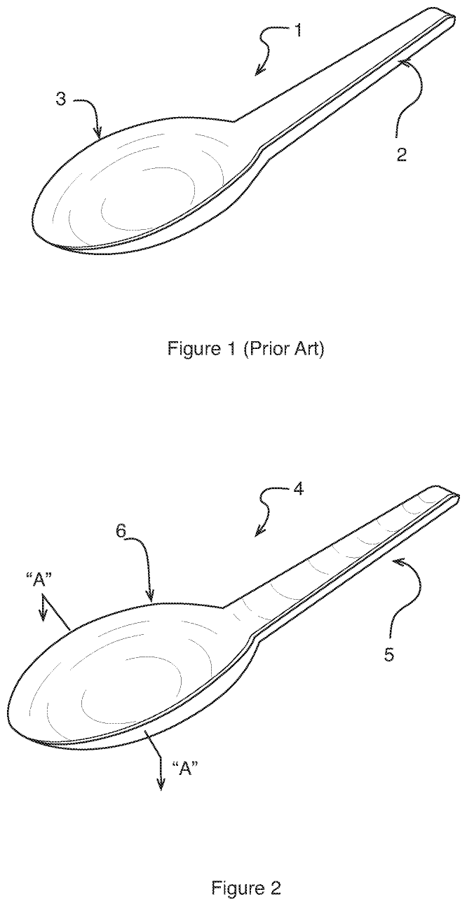

Referring firstly to FIG. 1 there is shown a conventional plastics disposable spoon 1 comprising a handle 2 and a dish-shaped serving end 3 for scooping and serving foodstuffs (not shown) or stirring liquids. The handle 2 is in the shape of an elongate inverted channel to improve its rigidity. The spoon 1 is easily manufactured by plastics material being heated to a suitable temperature and then injection moulded within a two-part mould whereafter, upon cooling, the spoon 1 is ejected from the mould. Such spoons and indeed other items of cutlery including knives, forks and drinks stirrers are inexpensive to make and provide the user with the convenience of being disposable after use although, as is well-known, such cutlery is not biodegradable in the generally accepted sense and the plastics itself is derived from oil, being a non-renewable energy source.

In FIG. 2 there is shown a disposable spoon 4 made in accordance with the method of the invention, the spoon having a handle 5 and a dish-shaped serving end 6. The handle 5 is in the shape of an elongate trough or channel to improve rigidity.

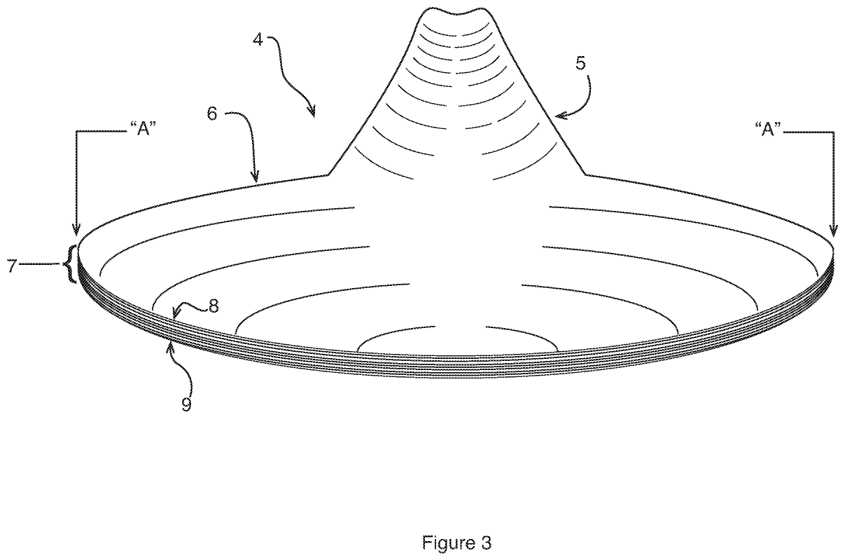

FIG. 3 is a part-sectional front view of the spoon 4 of FIG. 2 across section “A-A” in which it will be seen that it comprises a composite inner substrate 7 of over-laying food-grade paper sheets, typically seven such sheets, sandwiched between respectively upper 8 and lower 9 outer food-grade paper sheets, typically thinner than the sheets of the substrate 7 and typically coated on their outer surface with a waterproofing agent such as natural wax or food-grade oil. The thinner outer sheets 8,9, which may typically be half the thickness of the sheets of the substrate 7, are sufficiently thin so as to allow for the peripheral edges of the utensil to be cut in a clean and detailed manner even to the extent of providing a cutting or piercing surface in the case of, respectively, a knife and fork. The outer sheets 8,9 may also be over-printed with food-grade ink or dye for decorative purposes and/or for promotional placement, such as being printed with the name of the establishment on one or both sides. The paper sheets within the substrate 7 are connected together by an adhesive such as Henkel Adhesive AQUENCE BG 9040 LM (not shown) which, once set or cured, provides the substrate 7 with sufficient stiffness or rigidity such that the spoon 4 can be used for scooping, stirring or serving foodstuffs and beverages as the case may be. In this respect, it is believed that by combining a large number of paper sheets glued together to form a composite substrate with sufficient thickness or volume whereby to permit the cutlery item to perform its intended function, the substrate itself is surprisingly rigid when set or cured and in many respects its mechanical properties including strength and stiffness provides a construction that is comparable to plywood despite the fact that the paper sheets have no discernible grain preferentially imparting stiffness in one direction, as is the case with wood veneer used in the construction of plywood. In contrast, it has been found that forming a utensil such as the spoon 4 from a single solid substrate of paper or cardboard of equal thickness to the substrate 7 produces a substantially weaker utensil which is not fit for purpose. It is therefore believed that the mechanical strength of the substrate 7 is derived from an unexpected stiffening effect when multiple thin layers of food-grade paper are glued together, shaped or cut to form a required utensil, and then cured or otherwise allowed to set, with the respective layers of adhesive collectively imparting a granular structure to the cutlery item, providing it with sufficient strength and rigidity to an extent comparable with disposable cutlery items made from plastics.

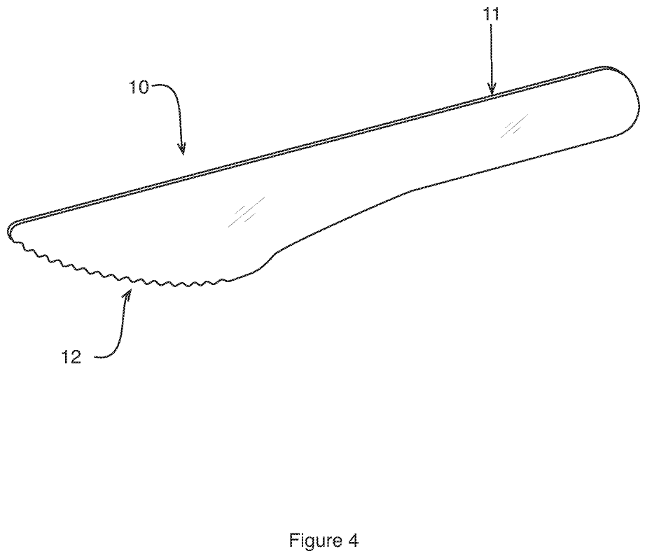

In FIG. 4 there is shown a perspective view of an item of disposable cutlery made in accordance with the method of the invention in the form of a table knife 10 which, in this instance, unlike the substantially 3-D shape of the spoon 4 described in FIGS. 2 and 3, is instead generally planar, having a handle 11 at one end which merges with a large serrated blade 12 at its other end, the somewhat chunky design contributing to the rigidity of the knife 10 to the extent that it requires no separate means of mechanical reinforcement, such as through the use of ribs or channels.

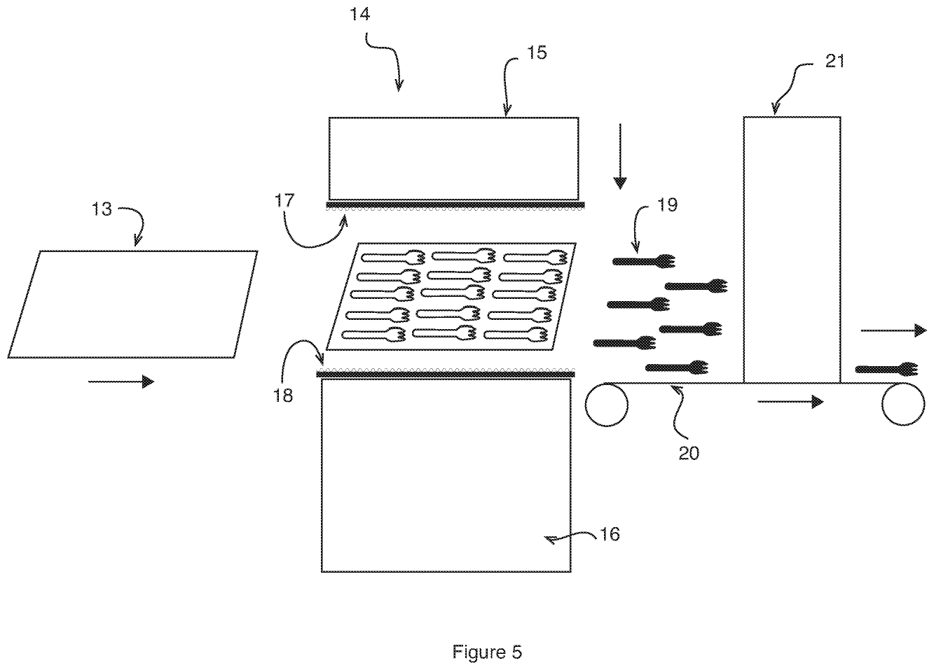

In FIG. 5 there is shown a schematic view of making a plurality of forks in accordance with one method of the invention, although it will be understood that other methods, including continuous forming of utensils may be used. In the drawing it will be seen that a prepared composite sheet 13 is moving towards a utensil-forming station shown generally at 14 comprising an upper mould half 15 and a lower mould half 16, each having respectively opposite cutlery item forming and cutting surfaces 17, 18 for forming, in this instance, a plurality of forks 19. The prepared composite sheet 13 is preferably made by drawing thin ribbon of food-grade paper from a respective set of rollers, dipping each innermost ribbon of paper in a bath of a suitable liquid adhesive such as Henkel Adhesive AQUENCE BG 9040 LM and thereafter overlying a required number of ribbons of paper including the outermost layers to form the client substrate 7 and cutting into a required length before being placed between the upper and lower mould halves 15, 16 so that when they are clamped together in the direction arrowed the pliability of the sheet 13 allows it to form to the required shape of cutlery, whereafter each item of cutlery is cut while the upper and lower mould halves 15, 16 are still clamped together. When the mould halves 15, 16 are then separated the moulded and cut items of cutlery, in this case a plurality of forks 19, are released from the sheet 13 to thereafter be moved along a conveyor 20 in the direction arrowed to an adhesive drying or curing station 21, such as a UV chamber of sufficient length to ensure that UV-settable adhesive between the various layers of paper making up the item of cutlery can set or cure before the cutlery drops off the end of the conveyor 20.

From the foregoing it will be seen that cutlery made in accordance with the invention is both fit for purpose in being strong enough and/or sharp enough for food handling, but is also disposable to the extent of even being compostable, that is to say, the cutlery will easily biodegrade without being subjected to any further industrial processes, such as are necessary when disposing of cutlery items made of PVA, even to the extent that, after use, cutlery made in accordance with the invention may be deposited on a compost heap comprising vegetable waste matter and lawn cuttings. The invention is therefore a considerable improvement over the prior art in that once the items of cutlery have been manufactured in accordance with the method of the invention they will naturally biodegrade even if disposed of in a landfill site.

1. A method of making compostable cutlery utensils (4, 10), the method including the steps, in any convenient order, of forming a pliable composite sheet (13) comprised of an internal substrate of overlaying food-grade paper sheets (7) of collective number and thickness suitable for making a required item of cutlery, the internal paper sheets (7) each being coated with a settable food-grade adhesive substance, such as by being dipped into a bath of liquid glue, applying an outer covering (8, 9) of food-grade paper to each major external side of the substrate to form a pliable composite sheet, thereafter forming the shape of the utensil, such as by the use of a two-part mould (17, 18) in the collective shape and size of the required utensil, removing, such as by cutting, the formed utensil from the composite sheet before the adhesive has set, and thereafter allowing or causing the adhesive substance to set to thereby produce a rigid compostable cutlery utensil (4, 10).

2. A method according to claim 1, wherein the number of sheets in the substrate for forming utensils in the shape of cutlery is between 6 and 10 such sheets.

3. A method according to claim 1, wherein the number of sheets in the substrate for forming utensils in the shape of cutlery is between 7 and 9 such sheets.

4. A method according to claim 1, wherein the outermost paper sheets (8, 9) covering the composite multi-layer substrate (7) are not coated with adhesive.

5. A method according to claim 1, wherein the outer covering sheets (8, 9) are thinner than the innermost sheets of the substrate (7).

6. A method according to claim 5, the innermost sheets (7) each being about 120 g and the outermost sheets (8, 9) being about 63 g.

7. A method according to claim 1, wherein the outermost sheets of paper (8, 9) are provided with a food-grade waterproofing agent such as oil, wax or acrylic.

8. A method according to claim 1, wherein the adhesive used in the manufacturing process is UV curable.

9. A method according to claim 8, further including the further step of forming the utensil while the adhesive is still wet or is otherwise not set or cured and thereafter causing the adhesive to harden by exposing it to UV radiation.

10. A composite cutlery utensil (4, 10) made in accordance with the method of claim 1.
